(19) United States
(12) Patent Application Publication
(10) Pub. No.: US 2026/0161961 A1
(43) Pub. Date: Jun. 11, 2026

(54) REPEATER MONITORING METHOD, MONITORING SYSTEM, AND COMPUTER READABLE STORAGE MEDIUM

(71) Applicant: SHENZHEN HUAPTEC CO., LTD, SHENZHEN (CN)

(72) Inventors: YANWEI WANG, SHENZHEN (CN); YIN KUANG, SHENZHEN (CN); YANLIN XIE, SHENZHEN (CN)

(21) Appl. No.: 19/016,337

(22) Filed: Jan. 10, 2025

(30) Foreign Application Priority Data
Dec. 9, 2024 (CN) 202411806841.1

(51) Int. Cl. G06N 5/01

(52) U.S. Cl. CPC G06N 5/01

(57) ABSTRACT

A repeater monitoring method, a monitoring system, and a computer readable storage medium are provided. The repeater monitoring method includes steps: acquiring operation data of the repeater subsystem during operation; performing data processing on the operation data to obtain target operation data; inputting the target operation data into a target decision forest for processing to obtain an abnormal value and an abnormal response decision of the repeater subsystem; and transmitting the abnormal value and the abnormal response decision to an embedded operation subsystem of the monitoring system, so that the embedded operation subsystem performs an alarm operation according to the abnormal value. The repeater monitoring method realizes real-time monitoring and intelligent management of the repeater subsystem, ensuring that an abnormal condition is quickly identified and transmitted to the embedded operation subsystem, thereby triggering the alarm operation. Therefore, reliability and safety are improved and maintenance costs and downtime are reduced.

### TECHNICAL FIELD

The present disclosure relates to a field of communication equipment management, and in particular to a repeater monitoring method, a monitoring system, and a computer readable storage medium.

### BACKGROUND

With continuous expansion and complexity of mobile communication networks, repeaters, as key equipment for enhancing network coverage and signal quality, are widely used in weak signal areas such as urban dead zones, indoor environments, tunnels, and rural areas. However, widespread deployment of the repeaters brings new challenges. Since the repeaters are responsible for relaying and amplifying base station signals, if the repeaters are not effectively monitored and managed, the repeaters may cause signal interference, uneven coverage, improper power regulation, and other problems, affecting overall network performance and user experience. Further, with advancement of modern communication, computing, network, and microelectronics technology, embedded Linux systems gradually meet development needs of a new generation of communication equipment. A Linux kernel thereof is widely used in various communication products with rich network protocols and transmission control protocol/Internet protocol (TCP/IP protocol) stack as well as domain name system (DNS) and a hypertext transfer protocol (HTTP).

With rapid development of computer technology and the popularization of the Internet, Web technology is widely used. Embedded Web server is a result of a combination of embedded technology and network technology, and the embedded Web server proposes an improved method for a remote monitoring system. Currently, in system design of the prior art, the embedded Web technology is applied to monitor a micro repeater equipment system, and two motherboards are generally designed. Two microcontroller units (MCUs) are installed on the two motherboards to respectively make a repeater system and a monitoring system. However, complexity and power consumption of BOM inevitably increase, especially in mass production, the cost also increase greatly.

### SUMMARY

An object of embodiments of the present disclosure is to provide a repeater monitoring method, a monitoring system, and a computer readable storage medium to solve technical problem that abnormalities are unable to be discovered in time and cost is high when monitoring a repeater.

In a first aspect, the present disclosure provides a repeater monitoring method applied to a repeater subsystem in a monitoring system. The repeater monitoring method includes steps:
acquiring operation data of the repeater subsystem during operation;
performing data processing on the operation data to obtain target operation data;
inputting the target operation data into a target decision forest for processing to obtain an abnormal value and an abnormal response decision of the repeater subsystem; and
transmitting the abnormal value and the abnormal response decision to an embedded operation subsystem of the monitoring system, so that the embedded operation subsystem performs an alarm operation according to the abnormal value.

In a second aspect, the present disclosure provides a monitoring system. The monitoring system includes a repeater subsystem and an embedded operation subsystem for performing the repeater monitoring method disclosed in the first aspect.

In a third aspect, the present disclosure provides a repeater monitoring device. The repeater monitoring device includes a sending unit, a processing unit, and a transmission unit. The sending unit is configured to acquire operation data of the repeater subsystem during operation. The processing unit is configured to perform data processing on the operation data to obtain target operation data. The processing unit is further configured to input the target operation data into a target decision forest for processing to obtain an abnormal value and an abnormal response decision of the repeater subsystem. The transmission unit is configured to transmit the abnormal value and the abnormal response decision to an embedded operation subsystem of the monitoring system, so that the embedded operation subsystem performs an alarm operation according to the abnormal value.

In a fourth aspect, the present disclosure provides a computer device. The computer device includes at least one processor and a memory communicated with the at least one processor.

The memory stores instructions executed by the at least one processor, and the instructions are executed by the at least one processor to enable the at least one processor to perform the repeater monitoring method disclosed in the first aspect.

In a fifth aspect, the present disclosure provides a computer-readable storage medium. The computer-readable storage medium includes at least one computer program stored therein. The at least one computer program includes program instructions, and when the program instructions are executed by at least one processor, the at least one processor performs the repeater monitoring method disclosed in the first aspect.

In the repeater monitoring method, the monitoring system, the repeater monitoring device, the computer device, and the computer readable storage medium of the present disclosure, the operation data of the repeater subsystem during operation is acquired first. Then, the data processing is performed on the operation data to obtain the target operation data. The target operation data is input into the target decision forest for processing to obtain the abnormal value and the abnormal response decision of the repeater subsystem. Finally, the abnormal value and the abnormal response decision are transmitted to the embedded operation subsystem of the monitoring system, so that the embedded operation subsystem performs the alarm operation according to the abnormal value.

The repeater monitoring method obtains the operation data of the repeater subsystem in real time, so a current state and performance of the repeater subsystem are acknowledged, thereby providing basic data support for subsequent data processing and anomaly detection. Then, by processing the operation data, noise and irrelevant information are filtered out, the target operation data that is valuable is extracted, which improves accuracy and reliability of data, so a more accurate data basis is provided for subsequent decision analysis. Then, by using the target decision forest to analyze the target operation data, an abnormal situation in system operation is efficiently identified, and a corresponding abnormal response decision is generated, thereby improving the accuracy and a response speed of the anomaly detection. Finally, by transmitting the abnormal value and the abnormal response decision to the embedded operation subsystem, real-time alarm operation is realized, and relevant personnel is reminded to handle it in time, thereby reducing an impact of failure of the repeater subsystem on an overall operation of the repeater, and improving the stability and safety of the repeater subsystem. Therefore, intelligent monitoring and abnormal management of the repeater subsystem are realized, and the operation efficiency and reliability are improved.

### BRIEF DESCRIPTION OF DRAWINGS

In order to clearly describe technical solutions in the embodiments of the present disclosure, the following will briefly introduce the drawings that need to be used in the description of the embodiments or the prior art. Apparently, the drawings in the following description are merely some of the embodiments of the present disclosure, and those skilled in the art are able to obtain other drawings according to the drawings without contributing any inventive labor.

FIG. 1A is a schematic diagram of a monitoring system according to one embodiment of the present disclosure.

FIG. 1B is a flow chart of an internal interaction of an embedded operation subsystem according to one embodiment of the present disclosure.

FIG. 2 is a flow chart of a repeater monitoring method according to one embodiment of the present disclosure.

FIG. 3 is a schematic diagram of a repeater monitoring device according to one embodiment of the present disclosure.

FIG. 4 is a schematic diagram of a computer device according to one embodiment of the present disclosure.

### DETAILED DESCRIPTION

In order to make objectives, technical solutions, and advantages of the present disclosure clearer, the following further describes the present disclosure in detail with reference to accompanying drawings and embodiments. It should be understood that the specific embodiments described here are only used to explain the present disclosure, but not to limit the present disclosure. Based on the embodiments of the present disclosure, all other embodiments obtained by those of ordinary skill in the art without creative work shall fall within the protection scope of the present disclosure.

It should be noted that, if there is no conflict, features in the embodiments of the present disclosure may be combined with each other, and are all within the protection scope of the present disclosure. In addition, although functional module division is performed in the schematic diagrams of devices, a logical order is shown in the flowchart. In some cases, the steps shown or described may be performed in a different module division form in the devices or in a different sequence in the flowchart. In addition, the terms such as “first”, “second”, and “third” used in the present disclosure do not limit a data execution order, and are merely for distinguishing same items or similar items that have basically the same function.

The present disclosure is described in detail below through specific embodiments.

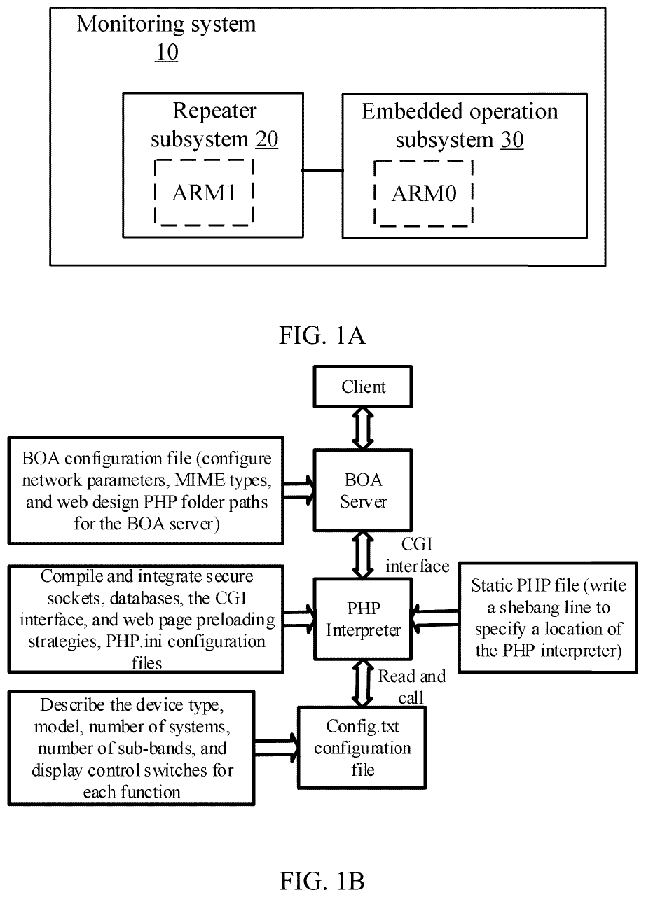

As shown in FIG. 1A, FIG. 1A is a schematic diagram of a monitoring system according to one embodiment of the present disclosure. The monitoring system is shown in FIG. 1A. The monitoring system 10 includes a repeater subsystem 20 and an embedded operation subsystem 30.

The monitoring system uses the asynchronous dual-core Advanced RISC Machines (ARM) of a Zynq Ultralscale+ MPSoC architecture as a core controller of the monitoring system. Two cores of the asynchronous dual-core ARM are respectively presented by ARM0 and ARM1. A Linux operation system is transplanted on ARM0 to run network services, and a suitable Web server is transplanted on the Linux operation system. In addition, ARM1 is configured to realize functional items of the repeater subsystem, and key data indicators such as gain, power, attenuation, radio frequency (RF) switch, sub-band frequency band, etc. are transmitted to ARM0 in real time for real-time data interaction. That is, in the embodiment, the repeater subsystem is processed according to ARM1, and the embedded operation subsystem is processed according to ARM0.

Specifically, the Zynq Ultralscale+ MPSoC architecture is a highly integrated multi-processor system-on-chip (SoC) for applications that require high-performance processing and flexible hardware configuration.

Specifically, the asynchronous dual-core ARM means that there are two ARM cores in the Zynq Ultralscale+ MPSoC. The two ARM cores are capable of running independently and performing different tasks, which improve processing power and efficiency of the monitoring system.

Specifically, the repeater subsystem (based on ARM1) is responsible for an actual operation of the repeater, including signal amplification, frequency adjustment, power control, etc. The repeater subsystem is specifically configured to monitor an operation status of the repeater in real time and collect key performance indicators. Collected data is transmitted to ARM0 for further processing and monitoring.

Specifically, the embedded operation subsystem (based on ARM0) is configured to run the Linux operation system and provide a network service interface. Through the transplanted Web server, the embedded operation subsystem is able to remotely access monitoring data, issue control commands, receive data from ARM1, perform real-time data interaction, store and analyze data, and update a user interface.

As shown in FIG. 1B, FIG. 1B is a flow chart of an internal interaction of the embedded operation subsystem according to one embodiment of the present disclosure. The internal interaction described in the figure is between a client and a server, and in particular to configurations and operation of a BOA server and a Hypertext Preprocessor (PHP) interpreter.

Specifically: the client sends a request and connects to the server, the BOA server receives the request from the client and uses a BOA configuration file to set a multipurpose Internet mail extensions (MIME) type and project file root directory, and the BOA server is communicated with the PHP interpreter through a common gateway interface (CGI) interface. The PHP interpreter compiles and processes secure sockets, databases, the CGI interface, and web page preloading strategies. The PHP interpreter parses a static PHP file requested by the client (the location of the PHP interpreter is specified through a shebang line). A Config.txt configuration file contains a device type, a device model, system parameters, subband information, and descriptions of display control switches of various functions.

The entire process describes a process of the request from the client being received and processed by the BOA server, a communication between the BOA server and the PHP interpreter, and how to use configuration files to configure and control the server and the PHP interpreter.

In view of this, the present disclosure proposes a repeater monitoring method to solve above problems, which is described in detail below.

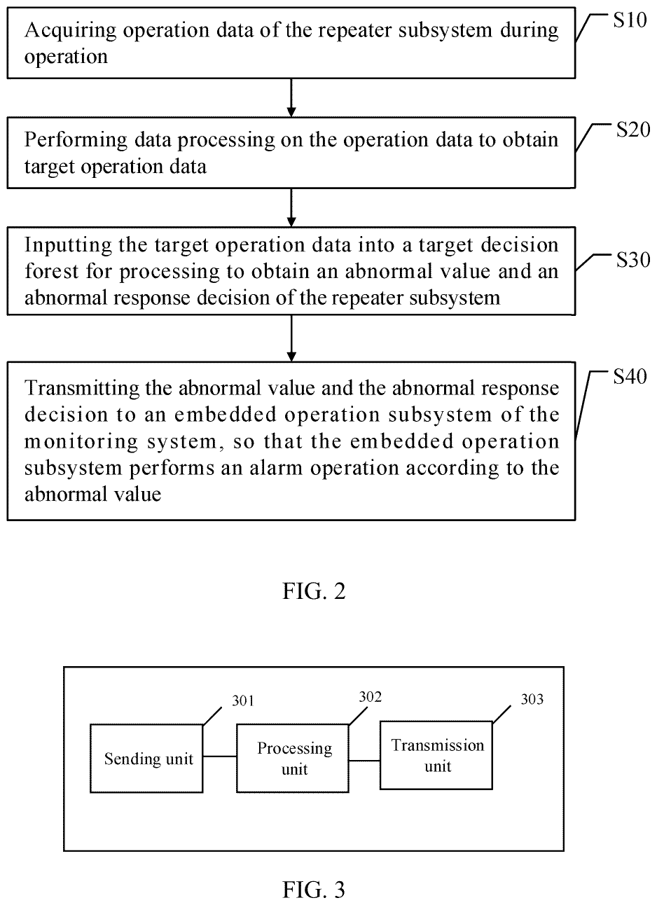

As shown in FIG. 2, FIG. 2 is a flow chart of the repeater monitoring method according to one embodiment of the present disclosure. The repeater monitoring method is applied to the repeater subsystem of the monitoring system. The monitoring system further includes the embedded operation subsystem. The repeater monitoring method includes steps S10-S40.

The step S10 includes acquiring operation data of the repeater subsystem during operation.

The operation data refers to information collected and recorded about performance indicators and an operation status of the repeater subsystem under normal working conditions. The operation data includes but is not limited to parameters such as a signal strength, an output power, receiving sensitivity, a temperature, a voltage, a current, a frequency offset, a bit error rate, a device status, an error log, and flow statistics, of the repeater subsystem.

Specifically, the signal strength is a received signal strength indicator (such as received signal strength indication (RSSI), reference signal receiving power (RSRP,) etc.). The signal quality is a signal quality indicator (such as signal to interference plus noise (SINR), signal-noise ratio (SNR), etc.). The device status is operation status information of the repeater subsystem (such as the temperature, the voltage, the current, etc.). The error log is an error and warning log generated during the operation of the repeater subsystem. The flow statistics are flow statistics such as data transmission rate and number of user connections.

An acquisition process of the operation data is real-time, that is, the operation data of the repeater subsystem is continuously collected to promptly detect any signs of performance degradation or potential failure of the repeater subsystem. Further operation data is acquired through a sensor, an analog-to-digital converter (ADC), a digital signal processors (DSP) or another monitoring device. The monitoring device is placed at an “edge area” where the operation data is generated, that is, the monitoring device is close to a data source.

During the acquisition process of the operation data, different acquisition frequencies is set according to monitoring needs, ranging from several times to thousands of times per second, to ensure timeliness and accuracy of the operation data.

Optionally, acquired operation data needs to be stored in a memory, a database or a log file for subsequent analysis and processing. The acquired operation data is configured for historical trend analysis, troubleshooting, and performance optimization.

It is seen that in the embodiment, accurate data support is provided for monitoring by acquiring the operation data of the repeater subsystem during operation.

The step S20 includes performing data processing on the operation data to obtain target operation data.

The data processing refers to a process of cleaning, converting, normalizing, aggregating, and other operations on the operation data to eliminate noise, correct errors, and extract the target operation data.

The target operation data is processed data, which is generally more accurate, more consistent, and more suitable for subsequent analysis (such as statistical analysis, machine learning model training, etc.).

In one optional embodiment, the step of performing data processing on the operation data to obtain the target operation data includes steps: obtaining a data type of each data in the operation data; calculating the data type of each data in the operation data to obtain first operation data corresponding to the data type of each data in the operation data; and aggregating all the first operation data to obtain the target operation data.

It is necessary to identify and classify the data type of each data in the operation data, such as signal strength data, temperature data, flow data, etc. Optionally, each data type is marked so that in subsequent processing steps, corresponding processing is performed for different types of the operation data.

Specifically, in the step of calculating the data type of each data in the operation data to obtain first operation data corresponding to the data type of each data in the operation data, data cleaning is performed first to remove noise and outliers in the operation data to ensure the accuracy and reliability of the target operation data. Then, data conversion is performed to convert different types of operation data into a unified format or unit. For example, the temperature data is uniformly converted into degrees Celsius, and the signal strength data is converted into dBm, etc. After that, data calculation is performed, that is, a corresponding calculation processing is performed for different types of the operation date. For example, an average, a maximum value, and a minimum value of the signal strength are calculated; a temperature change trend is calculated; a total amount and a peak value of flow are calculated, etc.

Calculation results of different types of the first operation data are summarized to form the target operation data.

It is seen that in the embodiment, by processing the operation data of the repeater subsystem, the target operation data is obtained. The target operation data is more accurate and reliable, providing valuable information support for subsequent decision analysis.

The step S30 includes inputting the target operation data into a target decision forest for processing to obtain an abnormal value and an abnormal response decision of the repeater subsystem.

The target decision forest (also known as random forest) is an integrated learning algorithm that improves prediction accuracy and stability by creating decision trees and combining output results of the decision trees. By inputting the target operation data into a decision forest model, abnormal values in the target operation data are automatically analyzed and identified, and abnormal response decisions are generated accordingly. Specifically, in the embodiment, the target decision forest is composed of a repeater operation decision tree and an environment operation decision tree.

The abnormal values in the target operation data are data points that are significantly different from the rest of the target operation data and may indicate an error or anomaly.

The abnormal response decisions refer to actions taken according to a predetermined rule or a predetermined strategy when the abnormal values are detected. The abnormal response decisions may include issuing an alarm, recording an event, automatically adjusting system settings, etc.

Specifically, the target operation data is input into the target decision forest, where each decision tree performs classification or regression analysis on the target operation data to identify patterns and relationships in the target operation data; the target decision forest identifies the abnormal values by comparing characteristics of the data points with normal behavior patterns learned in the target decision forest model. When a characteristic of one of the data points is significantly different from the normal pattern, the one of the data points is marked as an abnormal value. Once the abnormal value is detected, the target decision forest determines how to respond based on the predetermined rule or a predetermined algorithm. The predetermined rule includes threshold setting, probability calculation, conditional logic, etc. Each decision tree independently evaluates the target operation data and gives its own abnormal judgment. The target decision forest summarizes results of all decision trees and determines a final abnormal value and a final abnormal response decision by majority voting or average prediction value. If various decision trees indicate an anomaly, the monitoring system may take corresponding abnormal response decisions.

For example, when the target decision forest model identifies that an average signal strength is −67.67 dBm, it is noted that the average signal strength is low and may indicate a signal coverage problem. When the target decision forest model identifies that an average temperature is 26° C., it means that the temperature is within a normal range thereof and there is no abnormality in temperature. When the target decision forest model identifies that a total flow is 450 MB, it means that the total flow is within a normal range thereof and there is no abnormality in the flow. At this time, for the identified abnormality in signal strength, the target decision forest model generates the abnormal response decision.

For instance, an alarm is sent to notify an operator. Specifically, the operator is recommended to check and adjust a direction or a position of an antenna; or the operator is suggested that the number of repeaters in a coverage area needs to be increased.

It is that in the embodiment, abnormal conditions of the repeater subsystem is automatically identified and the actions are taken quickly, thereby improving the autonomy and reliability of the monitoring system.

The step S40 includes transmitting the abnormal value and the abnormal response decision to an embedded operation subsystem of the monitoring system, so that the embedded operation subsystem performs an alarm operation according to the abnormal value.

The embedded operation subsystem is an operation system integrated into a hardware device and is responsible for real-time monitoring and management of the operation status of the hardware device. The abnormal value and the abnormal response decision are transmitted to the embedded operation subsystem, so the monitoring system is allowed to identify the abnormal situations in time and perform a corresponding alarm operation to ensure the safe and stable operation of the repeater subsystem.

Transmitting process herein refers to sending the abnormal value and the abnormal response decision to the embedded operation subsystem through a communication interface.

Optionally, before transmission, the abnormal value and abnormal response decision are packaged into a data packet, and the data packet is sent through serial communication, network communication, or other suitable communication interface. The embedded operation subsystem receives the data packet and parses the abnormal value and response decision therein and the embedded operation subsystem performs corresponding alarm operations and/or automatic repair measures according to parsed information, and the embedded operation subsystem records the abnormal event and the measures taken for subsequent analysis and audit.

Specifically, when the target decision forest predicts a current abnormality in the repeater system, the embedded operation subsystem (i.e., the Linux operation system) performs following steps. The embedded operation subsystem immediately triggers the abnormal alarm, and sends alarm information to a web page display terminal of the computer through the Web server to remind the operation and maintenance personnel to pay attention. Then the abnormal situation and related data are recorded in a current log file for subsequent analysis and diagnosis, and different log files are parsed and displayed by the PHP interpreter. If the embedded operation subsystem is configured with an automatic processing strategy, the embedded operation subsystem may automatically process according to a predetermined processing plan, e.g., restart related modules, adjust parameters, or switch to backup systems, etc. Then, the embedded operation subsystem sends the abnormal information to a remote operation and maintenance center through the network, and the operation and maintenance personnel is able to view abnormal details through a remote monitoring system and perform remote diagnosis and processing. After the abnormal processing is completed, the embedded operation subsystem performs a system self-check to ensure that the embedded operation subsystem resumes normal operation. The embedded operation subsystem records self-check results in the log files; feedback the processing results and a current system status to the user through the web interface to ensure that the user understands a progress of the abnormal processing. Therefore, the embedded operation subsystem is able to effectively manage and handle the abnormal situations in the repeater subsystem, ensuring the stable operation and rapid recovery of the repeater subsystem.

It is seen that the embodiment is able to quickly respond to potential problems, reduces the need for human intervention, improves autonomous maintenance capability of the repeater subsystem, and ensures that the repeater subsystem is processed in timer when the abnormality occurs, thereby ensuring the stability and reliability of the entire communication network.

The repeater monitoring method obtains the operation data of the repeater subsystem in real time, so a current state and performance of the repeater subsystem are acknowledged, thereby providing basic data support for subsequent data processing and anomaly detection. Then, by processing the operation data, noise and irrelevant information are filtered out, the target operation data that is valuable is extracted, which improves accuracy and reliability of data, so a more accurate data basis is provided for subsequent decision analysis. Then, by using the target decision forest to analyze the target operation data, an abnormal situation in system operation is efficiently identified, and a corresponding abnormal response decision is generated, thereby improving the accuracy and a response speed of the anomaly detection. Finally, by transmitting the abnormal value and the abnormal response decision to the embedded operation subsystem, real-time alarm operation is realized, and relevant personnel is reminded to handle it in time, thereby reducing an impact of failure of the repeater subsystem on an overall operation of the repeater, and improving the stability and safety of the repeater subsystem. Therefore, intelligent monitoring and abnormal management of the repeater subsystem are realized, and the operation efficiency and reliability are improved.

In one optional embodiment, before the step of inputting the target operation data into the target decision forest for processing to obtain the abnormal value and the abnormal response decision of the repeater subsystem, the repeater monitoring method further includes steps: collecting historical operation data and environment operation data corresponding to the repeater subsystem; performing data processing on the historical operation data and the environment operation data to obtain a first operation decision tree corresponding to the historical operation data and a second operation decision tree corresponding to the environment operation data; and obtaining the target decision forest according to the first operation decision tree and the second operation decision tree.

The historical operation data includes normal data and abnormal data. The historical operation data refers to operation records of the repeater subsystem in past periods of time, including performance indicators such as the signal strength, the temperature, and the flow.

The environment operation data includes normal data and abnormal data. The environment operation data refers to data related to a repeater operation environment, such as weather, geographical location, surrounding buildings, and other factors that affect signal transmission.

The first operation decision tree is a decision tree model that reflects the operation status of the repeater subsystem and is constructed based on the historical operation data.

The second operation decision tree is a decision tree model that is constructed based on the environment operation data and reflects the operation environment of the repeater subsystem.

Before training the decision trees, the historical operation data and the environment operation data need to be processed, which include but is not limited to cleaning, standardization, and feature extraction, so as to improve the prediction ability of the decision tree models.

Optionally, the processed data is used to train the decision trees through machine learning algorithms such as a CART (classification and regression tree) algorithm or an ID3 (iterative binary tree 3) algorithm.

In a process of obtaining the target decision forest according to the first operation decision tree and the second operation decision tree, the first operation decision tree and the second operation decision tree are combined to form a comprehensive decision forest model (i.e., the target decision forest model) for more accurately analyzing and predicting the operation of the repeater subsystem.

Therefore, the target decision forest obtained by the historical operation data and the environment operation data in the embodiment provides a more comprehensive and accurate model for monitoring and predicting the repeater subsystem, thereby improving the fault detection and prevention capabilities of the monitoring system.

In one optional embodiment, the step of performing data processing on the historical operation data and the environment operation data to obtain the first operation decision tree corresponding to the historical operation data and the second operation decision tree corresponding to the environment operation data includes steps: performing feature processing on the historical operation data and the environment operation data to obtain historical feature data corresponding to the historical operation data and environment feature data corresponding to the environment operation data; performing importance ranking processing on the historical feature data and the environment feature data to obtain a first sequence corresponding to the historical feature data and a second sequence corresponding to the environment feature data; performing interaction effect processing on the first sequence and the second sequence to obtain historical feature interaction effect data and environment feature interaction effect data; and obtaining the first operation decision tree corresponding to the historical operation data and the second operation decision tree corresponding to the environment operation data according to the historical feature interaction effect data and the environment feature interaction effect data.

The feature processing may include but is not limited to feature extraction, feature selection, and feature conversion. A purpose of the feature processing is to extract most useful information for prediction tasks from original data. Specifically, the feature extraction is to use statistical methods, data mining techniques, or knowledge in the art to identify and extract key features in the original data. The feature selection is to rank the features according to their importance and select the most useful features for model prediction, which reduce the complexity of the model and the risk of overfitting.

The importance ranking processing is to determine the importance of the features through feature importance ranking and model-based feature selection (such as feature importance of the random forest).

Interaction analysis is configured to check interactions between the features and is performed through statistical tests (such as analysis of variance) or machine learning methods (such as feature combination).

When performing the importance ranking processing on the historical feature data, an algorithm (such as a random forest algorithm, a gradient boosting tree algorithm, etc.) is adopted to evaluate the importance of the historical feature data to determine which features have the greatest impact on the operation of the repeater subsystem. For example, the signal strength and the temperature may have a greater impact on the operation of the repeater subsystem, while the flow has a relatively smaller impact on the operation of the repeater subsystem. Therefore, the first sequence generated may be: the signal strength>the temperature>the flow.

When performing the importance ranking processing on the environment feature data, the same or similar algorithm as that used in the importance sorting of the historical feature data is adopted to evaluate the importance of the environment feature data to determine which environment features have the greatest impact on the operation of the repeater subsystem. For example, weather and surrounding buildings may have a greater impact on the operation of the repeater subsystem, while a geographical location has a relatively small impact on the operation of the repeater subsystem. Therefore, the second sequence generated may be: the weather>the surrounding buildings>the geographical location.

When performing the interaction effect processing on the first sequence and the second sequence to obtain historical feature interaction effect data and environment feature interaction effect data, the interaction effect between historical features and environment features is analyzed according to the first sequence and the second sequence. For example, a relationship between the signal strength and the temperature under different weather conditions is analyzed, or a relationship between the flow and a surrounding building density is analyzed. The interaction effect data reflects mutual influence between features, including the historical feature interaction effect data and the environment feature interaction effect data. For example, a relationship between the signal strength and the temperature on a sunny day may be different from that on a rainy day.

In the embodiment, more accurate and comprehensive decision tree models are constructed, which better capture a comprehensive impact of historical and environment factors on the performance of the repeater subsystem, thereby improving the prediction and diagnosis capabilities of the repeater subsystem.

In one optional embodiment, the step of obtaining the first operation decision tree corresponding to the historical operation data and the second operation decision tree corresponding to the environment operation data according to the historical feature interaction effect data and the environment feature interaction effect data includes steps: performing node screening on the historical feature interaction effect data and the environment feature interaction effect data to obtain historical feature initial node data and environment feature initial node data; performing splitting processing on the historical feature initial node data and the environment feature initial node data to obtain a historical feature classification candidate set and an environment feature classification candidate set; performing tree depth calculation according to the historical feature classification candidate set to obtain historical feature initial tree depth data; performing the tree depth calculation according to the environment feature classification candidate set to obtain environment feature initial tree depth data; performing recursive initialization processing according to the historical feature initial node data, the historical feature classification candidate set, and the historical feature initial tree depth data to obtain the first operation decision tree corresponding to the historical operation data; and performing the recursive initialization processing according to the environment feature initial node data, the environment feature classification candidate set, and the environment feature initial tree depth data to obtain the second operation decision tree corresponding to the environment operation data.

In a process of constructing the decision trees, the node screening refers to selecting features as nodes of the decision trees. The nodes divide data sets into subsets for classification or regression.

The historical feature initial node data and the environment feature initial node data are feature data selected as starting nodes of the decision trees after screening.

Specifically, the historical feature initial node data is initial nodes selected from the historical feature interaction effect data. For example, in interaction effect data of the signal strength, the temperature, and the flow, the interaction effect data of the signal strength and temperature are selected as the initial nodes.

Specifically, the environment feature initial node data is initial nodes selected from the environment feature interaction effect data. For example, in interaction effect data of the weather and the surrounding buildings, the interaction effect data of the weather and the surrounding buildings is selected as the initial nodes.

In the decision trees, splitting refers to dividing a current node into two or more child nodes according to a value of a certain feature. A process thereof is defined as the splitting processing.

In the splitting processing, the classification candidate set is a set of possible splitting nodes in the splitting processing. Each of the splitting nodes is an attempt to divide the initial node data according to different values of the features.

Specifically, the splitting processing is performed on the environment feature initial node data to obtain the environment feature classification candidate set. For example, a weather node may be split into child nodes based on different weather conditions (sunny, rainy, etc.).

The depth of each of the decision trees is calculated as the number of nodes on a longest path from a root node to a farthest leaf node. The depth of each of the decision trees is calculated to determine the complexity of the decision trees.

Specifically, the historical feature initial tree depth data is an initial tree depth of the first operation decision tree calculated based on the historical feature classification candidate set. The tree depth represents the longest path length from the root node to the leaf node. For example, if the historical feature classification candidate set contains 3 layers of splits, the initial tree depth is 3.

Specifically, the environment feature initial tree depth data is an initial tree depth of the second operation decision tree calculated based on the environment feature classification candidate set. For example, if the environment feature classification candidate set contains 4 layers of splits, the initial tree depth thereof is 4. The recursive initialization process is to recursively apply the above steps to create each of the nodes and each of the child nodes of the decision trees when constructing the decision trees until a stopping condition (such as a maximum depth of each of the decision trees, the minimum number of samples of node data, etc.) is met.

When performing recursive initialization processing according to the historical feature initial node data, the historical feature classification candidate set, and the historical feature initial tree depth data to obtain the first operation decision tree corresponding to the historical operation data, the first operation decision tree is recursively constructed by using the historical feature initial node data, the historical feature classification candidate set, and the historical feature initial tree depth data. During a recursive process, the best split nodes are continuously selected to split the best split nodes into the child nodes until the stopping condition is met (such as the tree depth thereof reaches the historical feature initial tree depth data or the node purity reaches a certain threshold). For example, starting from the signal strength node, the nodes thereof are split into the child nodes according to different signal strength thresholds, and then each of the child nodes is further split until the first operation decision tree is completely constructed.

When performing the recursive initialization processing according to the environment feature initial node data, the environment feature classification candidate set, and the environment feature initial tree depth data to obtain the second operation decision tree corresponding to the environment operation data, the second operation decision tree is recursively constructed by using the environment feature initial node data, the environment feature classification candidate set, and the environment feature initial tree depth data. A recursive process thereof is similar to that of constructing the first operation decision tree, and finally the second operation decision tree reflecting the environment operation status is obtained. For example, starting from the weather node, the nodes thereof are split into the child nodes thereof according to different weather conditions, and then each of the child nodes thereof is further split until the second operation decision tree is completely constructed.

During the recursive process, each of the nodes is split according to a corresponding classification candidate set until a predetermined stopping condition is reached.

In the embodiment, two decision trees are obtained through the above processes, one for the historical operation data and the other for the environment operation data. The two decision trees are used for classification or regression tasks to help the monitoring system predict a future state of the repeater subsystem or diagnose potential problems.

In one optional embodiment, the step of obtaining the target decision forest according to the first operation decision tree and the second operation decision tree includes steps: training the first operation decision tree and the second operation decision tree respectively to obtain a first prediction value of the first operation decision tree and a second prediction value of the second operation decision tree; and performing integrated processing on the first prediction value and the second prediction value to obtain the target decision forest.

When training the first operation decision tree to obtain the first prediction value of the first operation decision tree, the first operation decision tree constructed with the historical operation data is trained, and the first operation decision tree model is adjusted and optimized using the training data set. During the training process, the first operation decision tree learns how to classify or regress based on input features (such as the signal strength, the temperature, etc.) to obtain a corresponding prediction value. Finally, the first prediction value of the first run decision tree is obtained.

When training the second operation decision tree to obtain the second prediction value of the second operation decision tree, the second operation decision tree constructed with the environment operation data is trained, and the second operation decision tree model is adjusted and optimized using the training data set. During the training process, the second operation decision tree learns how to classify or regress based on input features (such as the weather, the sounding buildings, etc.) to obtain a corresponding prediction value. Finally, the second prediction value of the second run decision tree is obtained.

The integrated processing combines prediction results of the two operation decision trees to improve overall prediction performance and robustness. An integrated method may be a simple algorithm such as a voting method, a averaging method or the integrated method may be a complex algorithm such as a stacking method.

The first prediction value is obtained by applying the trained first operation decision tree to new historical operation data.

The second prediction value is obtained by applying the trained second operation decision tree to the new environment operation data.

Specifically, the integrated method may be a weighted average method, that is, different weights are assigned according to the importance of the first prediction value and the second prediction value, and then a weighted average is calculated as a final prediction result. Alternatively, the integrated method may be a voting mechanism, that is, for classification tasks, the voting mechanism is adopted to vote on prediction results of the two decision trees, and a category with more votes is selected as the final prediction result. Alternatively, the integrated method may be stacking, that is, the first prediction value and the second prediction value are served as new features and input into a higher-level model (such as linear regression, neural network, etc.) for further training and prediction. Therefore, through the integrated method, advantages of the two decision tree models are comprehensively utilized to improve the overall prediction performance.

In the embodiment, the first operation decision tree and the second operation decision tree are integrated to obtain the target decision forest. The target decision forest integrate information from the two decision trees to provide more accurate and stable results when monitoring and predicting the operation status of the repeater subsystem.

In one optional embodiment, the step of performing integrated processing on the first prediction value and the second prediction value to obtain the target decision forest includes steps: performing weighted averaging on the first prediction value and the second prediction value to obtain a first weight of the first operation decision tree and a second weight of the second operation decision tree; and obtaining the target decision forest according to the first weight of the first operation decision tree and the second weight of the second operation decision tree.

The weighted averaging is a method of combining the prediction values, where each of the prediction values is assigned a weight based on an importance thereof or reliability thereof. The first weight and the second weight are a number between 0 and 1 that represents the relative importance of each of the prediction values in the final prediction result.

The first weight corresponds to a contribution of the first operation decision tree in the target decision forest model; the second weight corresponds to a contribution of the second operation decision tree in the target decision forest model.

The first weight and the second weight are determined by a variety of methods, such as cross-validation, model performance evaluation (such as accuracy, mean square error, etc.) or using a specific algorithm (such as gradient boosting). The size of the weights reflects the influence of the corresponding decision tree in the target operation forest model. One of the decision tree models with better performance is given higher weights.

The target decision forest is the final model obtained by integrating the decision trees by weighted average. In the target decision forest, the prediction value of each of the decision trees contributes to the final prediction result according to its weight.

For classification problems, weighted averaging may involve weighting the predicted probabilities of each class and then selecting a class with the highest weighted average probability as the final prediction result. For regression problems, the weighted averaging directly weights the prediction value of each of the decision trees and then sums the prediction values up to get the final prediction result.

Specifically, once the weights of each of the decision trees are determined, the decision trees are combined into an integrated model, that is, the target decision forest. When making predictions, the prediction value of each of the decision trees is multiplied by a corresponding weight, and then all weighted prediction values are added together to form the final prediction result.

In the embodiment, the target decision forest more flexibly and effectively utilizes the information provided by different decision trees, thereby realizing improvements in prediction accuracy and model stability. Therefore, the target decision forest is suitable for when different decision tree models perform well in different situations. Through the weighted averaging, the advantages of different decision tree models are combined to obtain a more reliable prediction result.

It should be noted that, in each of the above-mentioned embodiments, there is not necessarily a certain order between the above-mentioned steps. Those skilled in the art should understand, based on the description of the embodiments of the present disclosure, that in different embodiments, the above-mentioned steps may have different execution orders. That is, the above-mentioned steps may be executed in parallel, may be executed interchangeably, etc.

In a second aspect of the present disclosure, the present disclosure provides a repeater monitoring device. The repeater monitoring device may be a software module. The software module includes instructions stored in a memory. At least one processor may access the memory and call the instructions for execution to execute the repeater monitoring method described in the above-mentioned embodiments.

As shown in FIG. 3, FIG. 3 is a schematic diagram of the repeater monitoring device according to one embodiment of the present disclosure. The repeater monitoring device is applied to the repeater subsystem in the monitoring system. The monitoring system further includes the embedded operation subsystem.

The repeater monitoring device includes a sending unit 301, a processing unit 302, and a transmission unit 303. The sending unit 301 is configured to acquire operation data of the repeater subsystem during operation. The processing unit 302 is configured to perform data processing on the operation data to obtain target operation data. The processing unit 302 is further configured to input the target operation data into a target decision forest for processing to obtain an abnormal value and an abnormal response decision of the repeater subsystem. The transmission unit 303 is configured to transmit the abnormal value and the abnormal response decision to an embedded operation subsystem of the monitoring system, so that the embedded operation subsystem performs an alarm operation according to the abnormal value.

The repeater monitoring device obtains the operation data of the repeater subsystem in real time, so the current state and performance of the repeater subsystem are acknowledged, thereby providing basic data support for subsequent data processing and anomaly detection. Then, by processing the operation data, noise and irrelevant information are filtered out, the target operation data that is valuable is extracted, which improves the accuracy and reliability of data are improved, so a more accurate data basis is provided for subsequent decision analysis. Then, by using the target decision forest to analyze the target operation data, an abnormal situation in system operation is efficiently identified, and a corresponding abnormal response decision is generated, thereby improving the accuracy and a response speed of the anomaly detection. Finally, by transmitting the abnormal value and the abnormal response decision to the embedded operation subsystem, real-time alarm operation is realized, and relevant personnel is reminded to handle it in time, thereby reducing an impact of failure of the repeater subsystem on an overall operation of the repeater, and improving the stability and safety of the repeater subsystem. Therefore, intelligent monitoring and abnormal management of the repeater subsystem are realized, and the operation efficiency and reliability are improved.

In the repeater monitoring method, the monitoring system, the repeater monitoring device, the computer device, and a computer readable storage medium of the present disclosure, the operation data of the repeater subsystem during operation is acquired first. Then, data processing is performed on the operation data to obtain the target operation data. The target operation data is input into the target decision forest for processing to obtain the abnormal value and the abnormal response decision of the repeater subsystem. Finally, the abnormal value and the abnormal response decision are transmitted to the embedded operation subsystem of the monitoring system, so that the embedded operation subsystem performs an alarm operation according to the abnormal value.

The repeater monitoring method obtains the operation data of the repeater subsystem in real time, so a current state and performance of the repeater subsystem are acknowledged, thereby providing basic data support for subsequent data processing and anomaly detection. Then, by processing the operation data, noise and irrelevant information are filtered out, the target operation data that is valuable is extracted, which improves the accuracy and reliability of the data, so a more accurate data basis is provided for subsequent decision analysis. Then, by using the target decision forest to analyze the target operation data, the abnormal situation in system operation is efficiently identified, and the corresponding abnormal response decision is generated, thereby improving the accuracy and the response speed of the anomaly detection. Finally, by transmitting the abnormal value and the abnormal response decision to the embedded operation subsystem, real-time alarm operation is realized, and the relevant personnel is reminded to handle it in time, thereby reducing the impact of failure of the repeater subsystem on the overall operation of the repeater, and improving the stability and safety of the repeater subsystem. Therefore, the intelligent monitoring and the abnormal management of the repeater subsystem are realized, and the operation efficiency and the reliability are improved.

It should be noted that the repeater monitoring device is able to execute the repeater monitoring method provided in the embodiments of the present disclosure, and has the corresponding functional modules for executing the repeater monitoring method and beneficial effects of the repeater monitoring method. For technical details not fully described in the embodiment of the repeater monitoring device, references are made to the repeater monitoring method provided in the embodiments of the present disclosure.

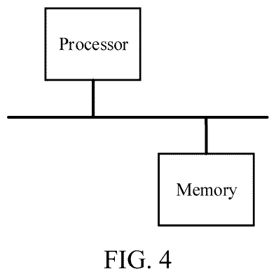

As shown in FIG. 4, FIG. 4 is a schematic diagram of a computer device according to one embodiment of the present disclosure. The computer device includes at least one processor and a memory communicated with the at least one processor. For example, the memory is connected to the at least one processor through a bus.

The at least one processor is configured to support the computer device to perform the corresponding functions in the repeater monitoring method in the above-mentioned embodiments. The at least one processor may be a central processing unit (CPU), a network processor (NP), a hardware chip, or any combination thereof. The hardware chip may be an application specific integrated circuit (ASIC), a programmable logic device (PLD), or a combination thereof. The PLD may be a complex programmable logic device (CPLD), a field-programmable gate array (FPGA), a generic array logic (GAL), or any combination thereof.

The memory is configured to stores program codes. The memory may be a volatile memory (VM), such as a random access memory (RAM). Alternatively, the memory may be a non-volatile memory (NVM), such as a read-only memory (ROM), a flash memory, a hard disk drive (HDD), a or solid-state drive (SSD). Alternatively, the memory may be a combination of the above types of memory.

The memory is configured to store non-volatile software programs, non-volatile computer executable programs and modules, such as program instructions/modules corresponding to the repeater monitoring method in the embodiments of the present disclosure. The at least one processor executes various functional applications and data processing of the repeater monitoring method and the repeater monitoring device by running the non-volatile software programs, the non-volatile computer executable programs and modules stored in the memory, so as to realize the functions of the various modules or units of the repeater monitoring method and the repeater monitoring device provided in the above-mentioned embodiments.

The memory includes a program storage area and a data storage area. The program storage area is configured to store an operation system and an application required for at least one function. The data storage area is configured to store data created when the repeater monitoring device works, which is not limited thereto. In some embodiments, the memory may be the memory remotely arranged relative to the at least one processor, and the remote memory is connected to the repeater monitoring device via the network. The network include, but is not limited to, the Internet, an intranet, a local area network, a mobile communication network, and any combinations thereof.

The one or more modules are stored in the memory, and when executed by the at least one processor, the repeater monitoring method in any of the above-mentioned embodiments is executed. For example, the steps described in the above-mentioned embodiments are executed to realize functions of the one or more modules described in the repeater monitoring device.

The present disclosure further provides a computer-readable storage medium. The computer-readable storage medium includes at least one computer program stored therein. The at least one computer program includes program instructions, and when the program instructions are executed by the at least one processor, the at least one processor performs the repeater monitoring method disclosed in the above-mentioned embodiments.

Those skilled in the art can understand that all or part of the processes in the above-mentioned embodiments can be implemented by instructing the relevant hardware through the at least one computer program, and the at least one computer program is stored in the computer-readable storage medium, and when the at least one computer program is executed, the at least one computer program may include the processes of the repeater monitoring method. The computer-readable storage medium may be the magnetic disk, the optical disk, the read-only memory (ROM) or the random access memory (RAM), etc.

The above disclosure is only optional embodiments of the present disclosure, which certainly cannot be used to limit the scope of rights of the present disclosure. Therefore, equivalent changes made according to the claims of the present disclosure should fall within the scope covered by the present disclosure.

What is claimed is:

1. A repeater monitoring method applied to a repeater subsystem of a monitoring system, comprising steps:
acquiring operation data of the repeater subsystem during operation;
performing data processing on the operation data to obtain target operation data;
inputting the target operation data into a target decision forest for processing to obtain an abnormal value and an abnormal response decision of the repeater subsystem; and
transmitting the abnormal value and the abnormal response decision to an embedded operation subsystem of the monitoring system, so that the embedded operation subsystem performs an alarm operation according to the abnormal value.

2. The repeater monitoring method according to claim 1, wherein the step of performing the data processing on the operation data to obtain the target operation data comprises steps:
obtaining a data type of each data in the operation data;
calculating the data type of each data in the operation data to obtain first operation data corresponding to the data type of each data in the operation data; and
aggregating all the first operation data to obtain the target operation data.

3. The repeater monitoring method according to claim 1, wherein before the step of inputting the target operation data into the target decision forest for processing to obtain the abnormal value and the abnormal response decision of the repeater subsystem, the repeater monitoring method further comprises steps:
collecting historical operation data and environment operation data corresponding to the repeater subsystem;
performing data processing on the historical operation data and the environment operation data to obtain a first operation decision tree corresponding to the historical operation data and a second operation decision tree corresponding to the environment operation data; and
obtaining the target decision forest according to the first operation decision tree and the second operation decision tree.

4. The repeater monitoring method according to claim 3, wherein the step of performing the data processing on the historical operation data and the environment operation data to obtain the first operation decision tree corresponding to the historical operation data and the second operation decision tree corresponding to the environment operation data comprises steps:
performing feature processing on the historical operation data and the environment operation data to obtain historical feature data corresponding to the historical operation data and environment feature data corresponding to the environment operation data;
performing importance ranking processing on the historical feature data and the environment feature data to obtain a first sequence corresponding to the historical feature data and a second sequence corresponding to the environment feature data;
performing interaction effect processing on the first sequence and the second sequence to obtain historical feature interaction effect data and environment feature interaction effect data; and
obtaining the first operation decision tree corresponding to the historical operation data and the second operation decision tree corresponding to the environment operation data according to the historical feature interaction effect data and the environment feature interaction effect data.

5. The repeater monitoring method according to claim 4, wherein the step of obtaining the first operation decision tree corresponding to the historical operation data and the second operation decision tree corresponding to the environment operation data according to the historical feature interaction effect data and the environment feature interaction effect data comprises steps:
performing node screening on the historical feature interaction effect data and the environment feature interaction effect data to obtain historical feature initial node data and environment feature initial node data;
performing splitting processing on the historical feature initial node data and the environment feature initial node data to obtain a historical feature classification candidate set and an environment feature classification candidate set;
performing tree depth calculation according to the historical feature classification candidate set to obtain historical feature initial tree depth data;
performing the tree depth calculation according to the environment feature classification candidate set to obtain environment feature initial tree depth data;
performing recursive initialization processing according to the historical feature initial node data, the historical feature classification candidate set, and the historical feature initial tree depth data to obtain the first operation decision tree corresponding to the historical operation data; and
performing the recursive initialization processing according to the environment feature initial node data, the environment feature classification candidate set, and the environment feature initial tree depth data to obtain the second operation decision tree corresponding to the environment operation data.

6. The repeater monitoring method according to claim 3, wherein the step of obtaining the target decision forest according to the first operation decision tree and the second operation decision tree comprises steps:
training the first operation decision tree and the second operation decision tree respectively to obtain a first prediction value of the first operation decision tree and a second prediction value of the second operation decision tree; and
performing integrated processing on the first prediction value and the second prediction value to obtain the target decision forest.

7. The repeater monitoring method according to claim 6, wherein the step of performing integrated processing on the first prediction value and the second prediction value to obtain the target decision forest comprises steps:
performing weighted averaging on the first prediction value and the second prediction value to obtain a first weight of the first operation decision tree and a second weight of the second operation decision tree; and
obtaining the target decision forest according to the first weight of the first operation decision tree and the second weight of the second operation decision tree.

8. A monitoring system, comprising:
a repeater subsystem; and
an embedded operation subsystem for performing the repeater monitoring method according to claim 1.

9. A computer device, comprising:
a memory; and
a processor;
wherein the memory is connected to the processor, the processor is configured to execute at least one computer program stored in the memory, and the processor executes the at least one computer program to enable the computer device to implement the repeater monitoring method according to claim 1.

10. A computer-readable storage medium comprising:
at least one computer program stored therein, wherein the at least one computer program comprises program instructions, and when the program instructions are executed by a processor, the processor performs the repeater monitoring method according to claim 1.
